(19) United States
(12) Patent Application Publication
(10) Pub. No.: US 2018/0183310 A1
(43) Pub. Date: Jun. 28, 2018

(54) MAGNETICALLY GEARED LEAD SCREW

(71) Applicants: Jonathan Z. Bird, Portland, OR (US); Mojtaba B. Kouhshahi, Portland, OR (US)

(72) Inventors: Jonathan Z. Bird, Portland, OR (US); Mojtaba B. Kouhshahi, Portland, OR (US)

(21) Appl. No.: 15/272,722

(22) Filed: Sep. 22, 2016

Related U.S. Application Data
(60) Provisional application No. 62/195,951, filed on Jul. 23, 2015.

(51) Int. Cl. H02K 41/02

(52) U.S. Cl. CPC H02K 41/02

(57) ABSTRACT

In some embodiments, the invention comprises a new type of high force density magnetically geared lead screw. It is shown that by using a helical inner and an annularly skewed ring translator a rotational motion can be converted into a magnetically geared translational motion. The advantage of the new design is that all of the magnets are continuously utilized to create the magnetically geared translational force.

### CROSS REFERENCE TO RELATED APPLICATIONS

This application claims priority to and the benefit of the filing date of U.S. Provisional Application No. 62/195,951, filed on Jul. 23, 2015, entitled “MAGNETICALLY GEARED LEAD SCREW”, which is hereby incorporated by reference in its entirety.

### BACKGROUND

Linear actuation is often achieved by utilizing either a hydraulic or mechanical gearing mechanism. Hydraulic actuators have been shown to be able to operate with force densities on the order of 35 MPa [1]. However, hydraulic and mechanical gearing mechanisms can suffer from poor efficiency and low reliability and often need regular servicing. Electromagnetic linear actuators (ELAs) have been extensively studies as a means of increasing both the reliability and efficiency of a linear actuator [2]. However, as the force density of an ELA is constrained by the current density the force density of proposed designs have not attained values higher than around 0.6 MPa [2]. Recently linear magnetic gearboxes (LMG) and magnetic lead screws (MLS) have been proposed as a means of increasing this force density. The LMG and MLS create force using only magnetic loading and therefore a very high magnetic air-gap shear stress can be sustained.

### BRIEF SUMMARY OF THE INVENTION

In some embodiments, the invention comprises a new type of high force density magnetically geared lead screw. It is shown that by using a helical inner and an annularly skewed ring translator a rotational motion can be converted into a magnetically geared translational motion. The advantage of the new design is that all of the magnets are continuously utilized to create the magnetically geared translational force.

### BRIEF DESCRIPTION OF THE DRAWINGS

FIG. 1 shows an example of a linear magnetic actuator with pᵢ=15 inner pole-pairs, Pₒ=6 outer pole pairs and nₜ=21 central ferromagnetic rings.

FIG. 2 provides one example of a magnetic lead screw in accordance with embodiments presented herein.

FIG. 3A Structure of proposed magnetically geared linear screw in accordance with embodiments presented herein

FIG. 3B shows some examples of the cross-sectional dimensional values or the screw of FIG. 3A.

FIG. 4A Radial flux densities and related spectrums: a) adjacent to inner rotor due to inner rotor magnets at r=17.55 mm)

FIG. 4B adjacent to outer rotor due to inner rotor magnets (at r=19.95 mm).

FIG. 5A Radial flux densities and related spectrums a) adjacent to outer rotor due to outer rotor (at r=19.95 mm)

FIG. 5B adjacent to inner rotor due to outer rotor (at r=17.55 mm)

FIG. 6 Force along the z-direction on different parts due to rotation of inner rotor

FIG. 7 Torque on different parts due to rotation only on the inner rotor

FIG. 8. Force in the z-direction on the different parts due to rotation of inner rotor and translation of translator at the same time

FIG. 9. Torque on each part due to rotation of the inner rotor and translation of translator at the same time

### DETAILED DESCRIPTION AND BEST MODE OF IMPLEMENTATION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Linear actuation is often achieved by utilizing either a hydraulic or mechanical gearing mechanism. Hydraulic actuators have been shown to be able to operate with force densities on the order of 35 MPa [1]. However, hydraulic and mechanical gearing mechanisms can suffer from poor efficiency and low reliability and often need regular servicing. Electromagnetic linear actuators (ELAs) have been extensively studies as a means of increasing both the reliability and efficiency of a linear actuator [2]. However, as the force density of an ELA is constrained by the current density the force density of proposed designs have not attained values higher than around 0.6 MPa [2]. Recently linear magnetic gearboxes (LMG) and magnetic lead screws (MLS) have been proposed as a means of increasing this force density. The LMG and MLS create force using only magnetic loading and therefore a very high magnetic air-gap shear stress can be sustained.

An example of a LMG is shown in Error! Reference source not found.; the LMG utilizes magnetic field heterodyning to create linear motion speed change without any physical contact [3-9]. The LMG, consists of three concentric tubular parts, an outer rotor containing, pₒ pole-pairs that can move with a translational velocity vₒ an inner rotor containing pᵢ pole-pairs that can move at velocity vᵢ and a central section that contains nₜ ferromagnetic rings. The rings can move at velocity vₜ. The ferromagnetic rings modulate the permanent magnet (PM) fields and therefore by choosing [3]

nₜ=pₒ+pᵢ (1)
the speed relationship between the translating moving parts will be [3]

vₜnₜ=vᵢpᵢ+vₒpₒ (2)

If vₒ=0 the gear ratio will then be Gᵣ=vₜ/vᵢ=pᵢ/nₜ. Atallah and Holehouse [3-5] demonstrated that a 3.25:1 gear ratio LMG is capable of operating with a force density of over 2 MPa. By mating a stator winding with the LMG a relatively high force density magnetically geared actuator can be created [6-8]. The LMG has been investigated for use in ocean power generation applications [6, 8] as well as for vehicle suspension [7].

An example of a MLS is shown in Error! Reference source not found. The MLS converts linear motion to rotary motion using helically shaped magnets [10-16]. The principle of operation of the MLS is analogous to a mechanical nut and screw but with a magnetic rotating “screw” and a magnetic translating “nut”. Both parts are made of helically disposed radially magnetized PMs on the inner and outer steel yokes. The relationship between the translating velocity and angular velocity is given by [17]

$$v = \frac{λ}{2 π} ω \qquad ( 3 )$$

where λ=lead of the rotor (as shown in Error! Reference source not found.). Wang calculated that the MLS could achieve force densities in excess of 10 MPa [10]. Recently, Holm experimentally verified the performance of a 17 kN MLS for a wave energy converter [14, 16] and Berg tested a MLS for active vehicle suspension [18]. In [14, 16, 18] the rotor was driven by a secondary motor. Pakdelian [19] and Lu [17] proposed a design in which a stator could be integrating into the MLS, and so this could create a more compact design.

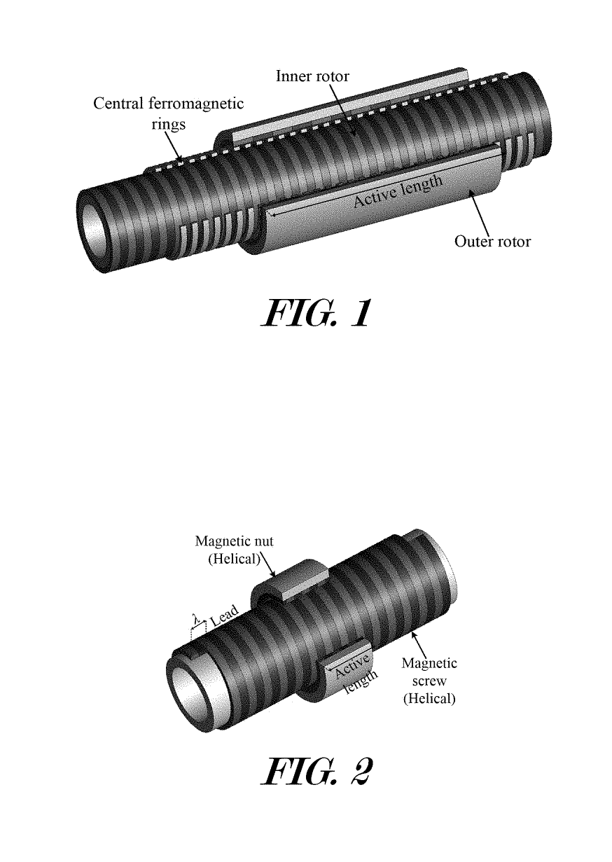

Both the LMG and MLS topologies require that one of the linear translating parts be made of magnet material and therefore if the linear stroke length is large then only a small portion of the magnet material will be utilized at any given time. Therefore, this will result in a low force-per-kilogram of magnet usage and consequently the design will be costly to build. In order to address this issue, in this paper a new type of magnetically geared lead screw (MGLS), as shown in FIG. 1, is proposed; the important characteristic of this new type of actuator is that the long-stroke translator is made of ferromagnetic material.

The MGLS consists of three concentric tubular parts: an inner rotor with pᵢ helically skewed, radially magnetized PM pole-pairs. An outer rotor with pₒ radially magnetized PM pole-pairs, which are in a ring and a translator which contains nₜ ferromagnetic annular skewed pole pieces. Due to the helical magnetization on the inner rotor, when the inner rotor is rotated, it will create a travelling field along the z-axis. This translating field will be modulated by the ferromagnetic pole pieces and therefore create additional spatial harmonics. The spatial harmonics will then interact with the outer rotor field. A constant translational force, F_{z} will be created only when (1) is satisfied. The rotation of the inner rotor with angular velocity, ωᵢ, will create a translational velocity, vᵢ, given by:

$$\begin{matrix}{v}_{i} = {k}_{i} {ω}_{i} where & ( 4 ) \\ {k}_{i} = \frac{{λ}_{i}}{2 π} & ( 5 )\end{matrix}$$

and λᵢ=inner rotor lead, which is twice the magnet pole-pitch (as shown in FIG. 1a). When the outer rotor is stationary the linear translator speed, vₜ can be calculated from (2) and the speed relationship is [20]:

$${v}_{t} = {v}_{i} \frac{{p}_{i}}{{n}_{t}} \qquad ( 6 )$$

For the case when pᵢ=15, nₜ=21 the gear ratio is then Gᵣ=pᵢ/nₜ=1.4. Substituting (4) into (5) gives

$${v}_{t} = \frac{{k}_{i} {p}_{i}}{{n}_{t}} {ω}_{i} \qquad ( 7 )$$

This equation relates the rotation speed of the inner rotor with the translational speed. The operation of the MGLS is similar to that of the MLS however the translator is entirely made of low-cost steel.

### Proof of Principle

The characteristics of the proposed MGLS have been investigated by using a 3-D finite element analysis (FEA) magnetostatic model. Using the values given in Table I the radial flux density due to the inner rotor PMs near the inner rotor and the outer rotor have been evaluated. The results are shown in Error! Reference source not found.; the corresponding spatial harmonics, when the translator is present, is also shown. Error! Reference source not found. shows the same plots when the PMs are only present on the outer rotor. The modulation effect of the translator is clearly evident. FIG. 1. (a) Structure of proposed magnetically geared linear screw and (b) shows the cross-sectional dimensional values.

TABLE I
SUMMARY OF DESIGN PARAMETERS

| Parameter | | Value | Unit |
|---|---|---|---|
| Outer rotor | Pole-pairs, pₒ | 6 | — |
| (fixed) - not | Outer radius, rₒₒ | 26 | mm |
| skewed | Back iron, l_{ob} | 4 | mm |
| | Magnet thickness, lₒₘ | 2 | mm |
| | Pole-pitch, wₒ | 8.75 | mm |
| | Airgap length, l_{g} | 0.5 | mm |
| | Axial length, L | 105 | mm |
| Translator - | Pole pieces, nₜ | 21 | |
| annular skewed | Outer radius, rₜₒ | 19.5 | mm |
| | Steel thickness, lₜ | 1.5 | mm |
| | Pole-pitch, wₜ | 2.5 | mm |
| Inner rotor - | Pole pairs, pᵢ | 15 | — |
| helically skewed | Inner radius, rᵢᵢ | 11.5 | mm |
| | Outer radius, rᵢₒ | 17.5 | mm |
| | Back iron, l_{ib} | 4 | mm |
| | Magnet thickness, lᵢₘ | 2 | mm |
| | Pole-pitch, wᵢ | 3.5 | mm |
| | Lead, λᵢ | 7 | mm |
| Material | NdFeB magnet, Hitachi NMX- | 1.25 | T |
| | 40CH | | |
| | 416 steel resistivity (translator) | 57.0 | μΩ- |
| | | | cm |
| | 1018 steel resistivity (back iron) | 15.9 | μΩ- |
| | | | cm |

When the inner rotor is rotated by 360° while the outer rotor and translator are kept stationary an axial force along the z-axis is created as well as a torque. FIG. 2 shows the calculated forces when using the parameters given in Table 1. It can be noted the net force on the three parts must satisfy

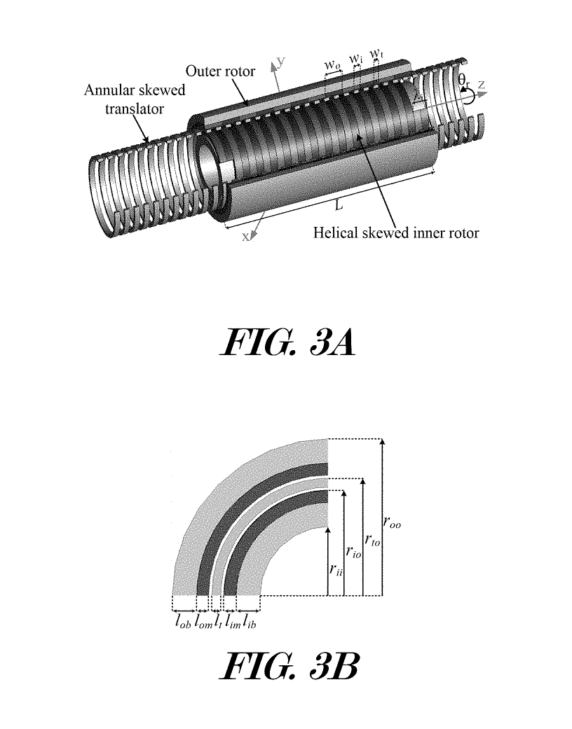

Fᵢ+Fₒ+Fₜ=0 (8)
where Fᵢ=inner rotor force, Fₜ=translator force, Fₒ=outer rotor force. The torque on the MGLS components is shown in FIG. 3 it can be noted that because the helical structure of the inner rotor and the translator's annular skew a torque is created only on these two parts. The outer rotor does not experience any torque since it is not skewed. The torque must therefore satisfy:

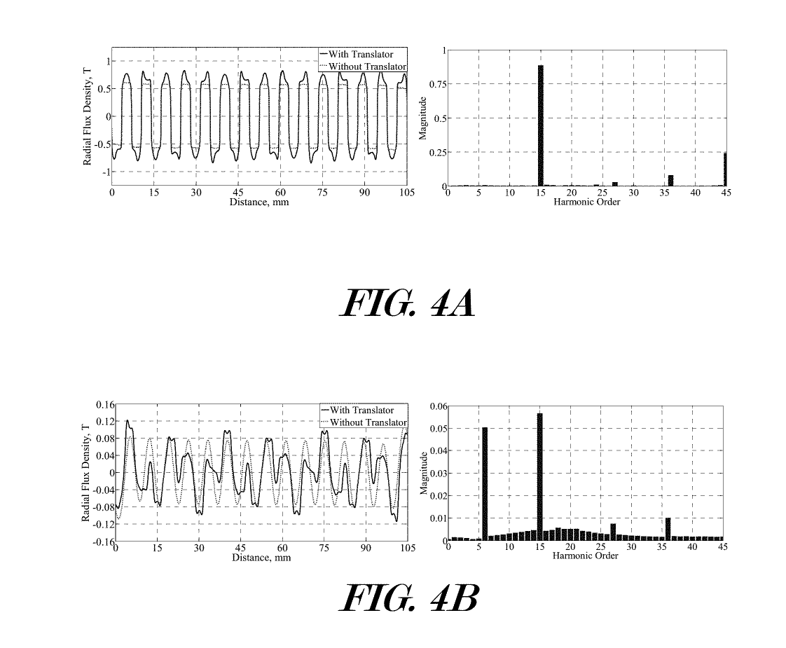

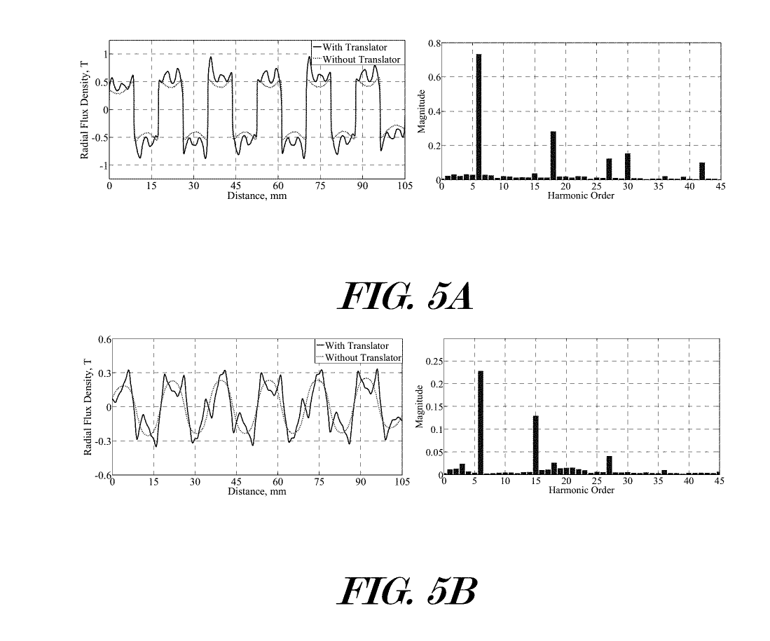

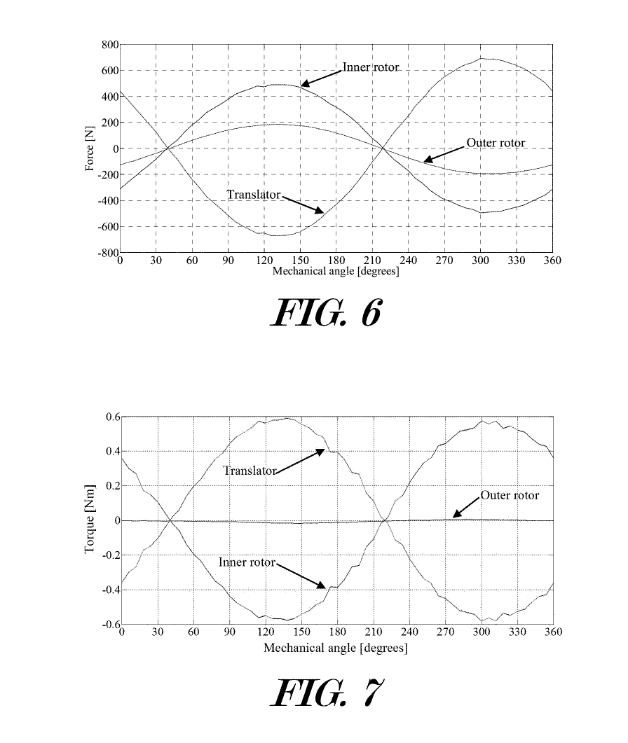

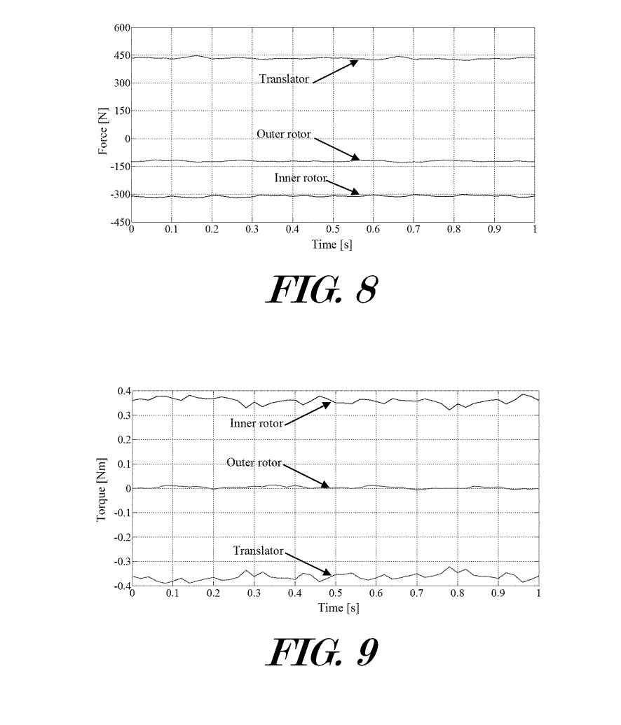

Tᵢ+Tₜ=0 (9)
where Tᵢ and Tₜ are the torque on the inner rotor and translator respectively. By having both rotation of the inner rotor and translation of the translator at the same time a constant force in the z-direction can be created. The force and torque on the different parts when ω₀=60 rpm and vₜ=5 mm/s is shown in FIG. 4 and Error! Reference source not found. respectively.

Assuming no losses the power flow relationship must satisfy

Fᵢvₜ+Tᵢωᵢ=0 (10)

FIG. 2 Force along the z-direction on different parts due to rotation of inner rotor

FIG. 3 Torque on different parts due to rotation only on the inner rotor and by substituting (7) into (10) and rearranging one obtains

$${T}_{i} = - {F}_{t} \frac{{k}_{i} {p}_{i}}{{n}_{t}} \qquad ( 11 )$$

Therefore, the gear ratio reduces the torque needed to create the translational force. FIG. 4. Force in the z-direction on the different parts due to rotation of inner rotor and translation of translator at the same time

This disclosure has presented a new type of MGLS that can be utilized for linear actuation. One of the advantages of the proposed MGLS over prior-art designs such as LMG and MLS is that the MGLS translator does not need to be made from magnetic material and therefore the cost of the actuator, especially when used in long stroke applications should be significantly lower.

### REFERENCES (INCORPORATED HEREIN BY REFERENCE)

[1] R. H. Hansen, T. O. Andersen, and H. C. Pedersen, “Model based design of efficient power take-off systems for wave energy converters,” presented at The Twelfth Scandinavian International Conference on Fluid Power, Tampere, Finland May 18-20, 2011.
[2] Y. Fujimoto, T. Kominami, and H Hamada, “Development and Analysis of a High Thrust Force Direct-Drive Linear Actuator,” IEEE Trans. Ind. Elect., vol. 56,5, pp. 1383-1392, 2009.
[3] K. Atallah, J Wang, and D. Howe, “A high-performance liner magnetic gear,” J. Appl. Phy., vol. 97, p. 10N516, 2005.
[4] K. Atallah, J Wang, S. Mezani, and D. Howe, “A novel high-performance linear magnetic gear,” IEEJ Trans. Ind. Appl., vol. 126,10, pp. 1352-1356, 2006.
[5] R. C. Holehouse, K. Atallah, and W. Jiabin, “Design and Realization of a Linear Magnetic Gear,” IEEE Trans. Magn., vol. 47,10, pp. 4171-4174, 2011.
[6] W. Li, K. T. Chau, and J. Z. Jiang, “Application of Linear Magnetic Gears for Pseudo-Direct-Drive Oceanic Wave Energy Harvesting,” IEEE Trans. Magn., vol. 47,10, pp. 2624-2627, 2011.
[7] W. Li, S. Gao, D. Wu, and X. Zhang, “Design of a linear magnetic-geared free-piston generator for series hybrid electric vehicles,” in IEEE Vehicle Power and Propulsion Conference (VPPC), pp. 1-6, 1-3 September, 2010.
[8] N. Shuangxia, S. L. Ho, and W. N. Fu, “Performance Analysis of a Novel Magnetic-Geared Tubular Linear Permanent Magnet Machine,” IEEE Trans. Magn., vol. 47,10, pp. 3598-3601, 2011.
[9] W. Li, K. T. Chau, and J. Li, “Simulation of a Tubular Linear Magnetic Gear Using HTS Bulks for Field Modulation,” IEEE Trans. Appl. Super., vol. 21,3, pp. 1167-1170, 2011.
[10] J. Wang, K. Atallah, and W. Wang, “Analysis of a Magnetic Screw for High Force Density Linear Electromagnetic Actuators,” IEEE Trans. Magn., vol. 47,10, pp. 4477-4480, 2011.
[11] R. K. Holm, N. I. Berg, M. Walkusch, P. O. Rasmussen, et al., “Design of a Magnetic Lead Screw for Wave Energy Conversion,” IEEE Trans. Ind. App., vol. 49,6, pp. 2699-2708, 2013.
[12] S. Pakdelian, N. W. Frank, and H. A. Toliyat, “Magnetic Design Aspects of the Trans-Rotary Magnetic Gear,” IEEE Trans. Energy Conv., vol. 30,1, pp. 41-50, 2015.
[13] L. Kaiyuan and W. Weimin, “Electromagnetic Lead Screw for Potential Wave Energy Application,” IEEE Trans. Magn., vol. 50,11, pp. 1-4, 2014.
[14] R. K. Holm, N. I. Berg, M. Walkusch, P. O. Rasmussen, et al., “Design of a Magnetic Lead Screw for Wave Energy Conversion,” IEEE Trans. Ind. Appl., vol. 49,6, pp. 2699-2708, 2013.
[15] J. Ji, Z. Ling, J. Wang, W. Zhao, et al., “Design and Analysis of a Halbach Magnetized Magnetic Screw for Artificial Heart,” IEEE Trans. Magn., vol. PP, 99, pp. 1-1, 2015.
[16] N. I. Berg, R. K. Holm, and P. O. Rasmussen, “Theoretical and Experimental Loss and Efficiency Studies of a Magnetic Lead Screw,” IEEE Trans. Ind. Appl., vol. 51,2, pp. 1438-1445, 2015.
[17] K. Lu and W. Wu, “Electromagnetic Lead Screw for Potential Wave Energy Application,” IEEE Trans. Magn., vol. 50,11, pp. 1-4, 2014.
[18] N. I. Berg, R. K. Holm, and P. O. Rasmussen, “Design and test of a novel magnetic lead screw for active suspension system in a vehicle,” in Inter. Conf. Elect. Mach., Berlin, pp. 470-477, 2-5 September 2014, 2014.
[19] S. Pakdelian, N. W. Frank, and H. A. Toliyat, “Principles of the Trans-Rotary Magnetic Gear,” IEEE Trans. Magn., vol. 49,2, pp. 883-889, 2013.
[20] R. C. Holehouse, K. Atallah, and W. Jiabin, “Design and Realization of a Linear Magnetic Gear,” Magnetics, IEEE Transactions on, vol. 47,10, pp. 4171-4174, 2011.

What is claimed is:

1. A high force density magnetically geared lead screw.
